(19) United States
(12) Patent Application Publication
(10) Pub. No.: US 2017/0232621 A1
(43) Pub. Date: Aug. 17, 2017

(54) FOLDING KNIFE WITH CONTROLLABLE FOLDING AND UNFOLDING MECHANISM

(71) Applicant: Sam Sung, West Covina, CA (US)

(72) Inventor: Sam Sung, West Covina, CA (US)

(21) Appl. No.: 15/433,985

(22) Filed: Feb. 15, 2017

Related U.S. Application Data
(60) Provisional application No. 62/295,405, filed on Feb. 15, 2016.

(51) Int. Cl. B26B 1/02

(52) U.S. Cl. CPC B26B 1/02

(57) ABSTRACT

A folding knife may include a blade, a handle and a bearing located within the handle. In one embodiment, the bearing may include a first donut-shaped ring unit disposed adjacent to a blade through hole on one side of the blade and a second ring unit disposed adjacent to the blade through hole on the other side of the blade. A plurality of protruding units facing the blade are disposed on an outer surface of the first ring unit and second ring unit. The blade has a plurality of positioning protrusions surrounding the blade through hole on both sides of the blade corresponding to the protruding units, and the movement and position of the blade can be determined by relative positions between the positioning protrusions and the protruding units. Thus, the movement of the blade can be easily controlled and managed by the force exerted by the user.

### CROSS-REFERENCE TO RELATED APPLICATIONS

This application claims priority under 35 U.S.C. §119 (e) to U.S. Provisional Patent Application Ser. No. 62/295,405, filed on Feb. 15, 2016, the entire contents of which are hereby incorporated by reference.

### FIELD OF THE INVENTION

The present invention relates to a mechanism for a folding knife, and more particularly to a folding knife with a controllable blade folding/unfolding mechanism.

### BACKGROUND OF THE INVENTION

Folding knives, or so-called pocket knives, have been around for over a long period of time and are well known in the art. Initially, folding knives were a single blade housed between two handle portions and rotatable around a pivot point such as a screw or rivet at one end of the handle. During use, the blade is rotated approximately 180 degrees such that the blade extends from the handle and the blade and handle share a common longitudinal plane. The handle and tang end of the blade come in contact to prevent the blade from over-rotating and to provide a solid cutting implement. For storage, the blade is rotated the opposite direction the same approximate 180 degrees, and stored in a cavity within the handle. With the blade stored, the overall length of the knife is approximately 40% shorter, thereby allowing for convenient storage in, for example, a pocket. The small size of such a knife makes it desirable as a portable and efficient means of having a cutting implement available at all times.

A general area of improvement has been in the opening of the knife blade. Originally, the blade had a recess cut into the side of the blade where a fingernail could catch and extract the blade from its stored position. The need and/or desire for the ability to open a blade using only one hand spurred a number of competing modifications, such as a thumb stud mounted on the side of the blade, a portion of the blade tang protruding out of the handle, or even a button released spring-assisted opening mechanism. Some of these mechanisms that exert stored potential energy on the blade and eject the blade from the storage cavity at high speed have been classified as illegal weapons and subsequently outlawed in some, but not all, jurisdictions. This causes considerable problems for a person who may legally carry such a knife in his own jurisdiction, and therefore without thinking carries it into another jurisdiction where it has been outlawed. One common feature though, is the placement of a release button or operating lever for a blade-opening device. Traditional placement of such mechanisms has been on the side of the blade or on the side of the handle, enlarging the tool and potentially providing a point where clothing or other items can be snagged or caught on the mechanism.

For example, U.S. Pat. No. 6,145,202 (the '202 patent) to Onion discloses a mechanism in a folding knife that urges the blade to move to an open and alternatively to a closed position. The knife generally consists of a blade member having a tang extending outwardly from the blade; a handle having at least one recessed portion; a bar pivotally connecting the tang and the handle; and a spring engaging the blade wherein the spring is housed within the recessed portion of the handle. Generally, in the '202 patent, the blade must be moved manually a certain distance whereupon the mechanism serves to complete the movement of the blade without the application of further outside force by the user.

U.S. Pat. No. 6,338,431 to Onion discloses a folding knife having a blade with a tang, and a handle with an end to which the tang is pivotally connected. The blade is rotatable relative to the handle about a pivot axis between an open position in which the blade is extended away from the handle and a closed position in which the blade is at least partially received within the handle. The folding knife may also include a post slidably held by the blade to slide along at least a portion of the blade between a retracted position and a locking position. When the blade is open and the post is in the locking position, the handle and post block pivoting of the blade from the open position toward the closed position. Similar to the '202 patent, the folding knife has a spring mechanism that allow the knife blade to be easily pivoted into the open position. Thus, there remains a need for a new and improved mechanism to replace the spring-assisted opening mechanism to overcome the problems stated above.

### SUMMARY OF THE INVENTION

It is an object of the present invention to provide a blade opening/closing mechanism for a folding knife without a spring-assisted mechanism.

It is another object of the present invention to provide a blade opening/closing mechanism for a folding knife so that the extent of the blade opening is controllable.

It is a further object of the present invention to provide a blade opening/closing mechanism for a folding knife so that the user can operate the folding knife even with one hand.

In one aspect, a folding knife may include a blade, a handle and a bearing located at a front end of the handle. In one embodiment, the handle may include a first side portion, a first inner piece, a second side portion and a second inner piece. A receiving space may be created between the first inner piece and the second inner piece to receive the blade when the knife is folded.

The handle may include through holes, each of which is located on a front end of the first side portion and second side portion respectively. The bearing may include a first donut-shaped ring unit disposed adjacent to a blade through hole on one side of the blade and a second ring unit disposed adjacent to the blade through hole on the other side of the blade. A plurality of protruding units facing the blade are disposed on an outer surface of the first ring unit and second ring unit. In one embodiment, each protruding unit is a hemisphere. A first protecting ring and a second protecting ring are disposed on a surface opposite to the protruding units of the first and second ring units respectively. The size of the protecting rings and is slighting larger than the first and second ring units, and the first and second ring units are configured to guide the movement of the blade without the spring-assisted mechanism.

More specifically, the blade has a plurality of positioning protrusions surrounding the blade through hole on both sides of the blade corresponding to the protruding units, and the positioning protrusions and the protruding units are movably engaged with each other, so the movement and position of the blade can be determined by relative positions between the positioning protrusions on the blade and the protruding units on the ring units. Thus, the movement of the blade can be easily controlled and managed by the force exerted by the user.

Each of the first inner piece and the second inner piece has an inner through hole respectively to receive corresponding protecting rings. A pair of screws are configured to insert into handle through holes, the inner through holes, the protecting rings, the ring units, and the blade through hole to pivotally secured the blade on the front portion of the handle. It is noted that a plurality of auxiliary screws are configured to further secure the first side portion, the first inner piece, the second side portion and the second inner piece.

When in use, the knife in a closed position is grasped with the rear end of the handle towards the user's wrist and bottom of the handle resting in the palm resulting in placement of a protruding portion of the blade in close proximity to the user's index finger. Force can then be applied to the protruding portion, so the blade can be rotated in a clockwise manner around the screws until the blade is fully extended, which is about 180 degrees change from its closed position. It is noted that the extent of the clockwise movement of the blade can be controlled by the force applied by the user. More specifically, as stated above, the movement of the blade in the present invention can be guided by the positioning protrusions on the blade and the protruding units on the ring units, so the user can adjust the force exerted on the protruding portion of the blade to further control the movement of the blade.

### BRIEF DESCRIPTION OF THE DRAWINGS

FIG. 1 illustrates a perspective view of the folding knife in the present invention when the folding knife is fully extended.

FIG. 2 illustrates an exploded view of the folding knife in the present invention.

FIG. 3 illustrates a schematic view of the folding knife in the present invention when the blade is restored in the receiving space.

FIG. 4 illustrates a schematic view of the folding knife in the present invention when the blade is fully extended.

FIG. 5 is a bottom view of the folding knife in the present invention when the blade is restored in the receiving space.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In order to further understand the goal, characteristics and effect of the present invention, a number of embodiments along with the drawings are illustrated as following:

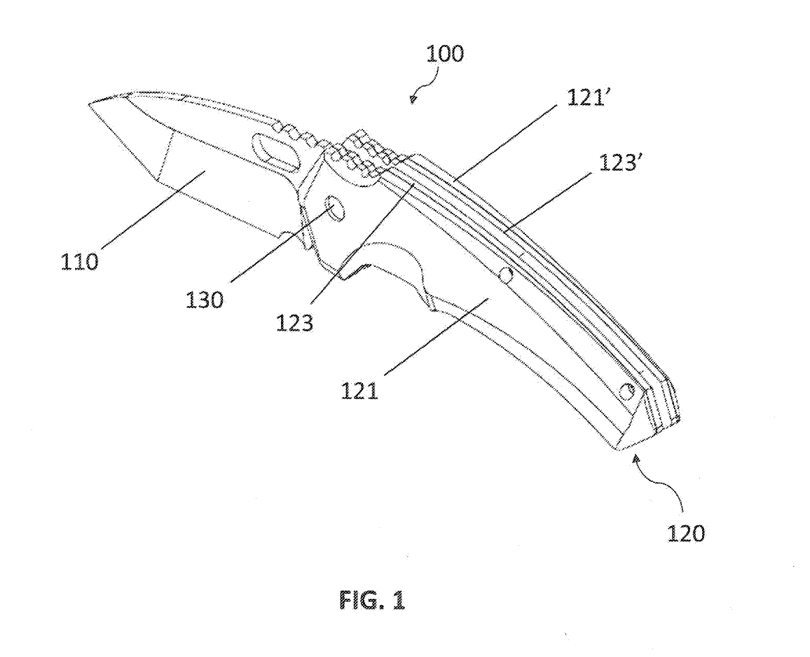

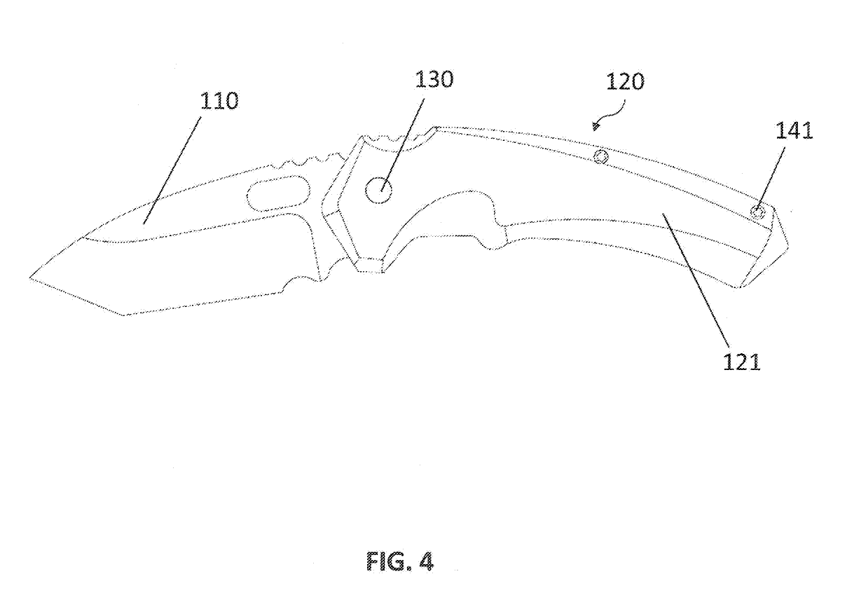

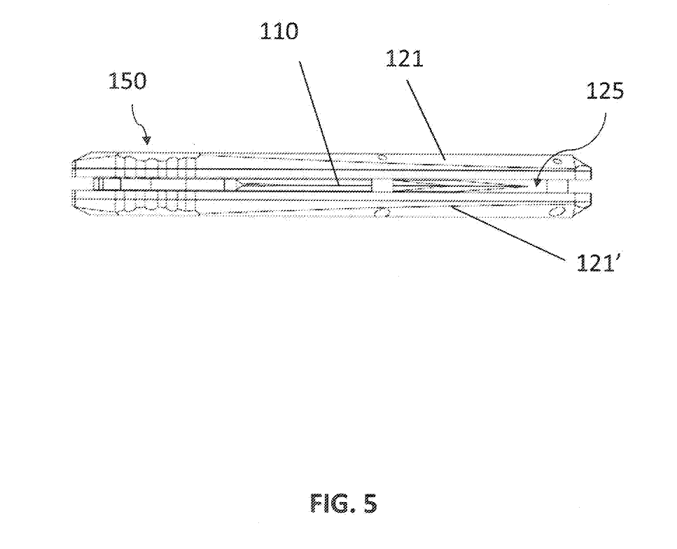

In one aspect, referring to FIGS. 1 to 5, a folding knife 100 may include a blade 110, a handle 120 and a bearing 150 located at a front end of the handle 120, and the blade 110 is pivotally connected with the handle 120 and the bearing 150. In one embodiment, the handle 120 may include a first side portion 121, a first inner piece 123, a second side portion 121′ and a second inner piece 123′. A receiving space 125 may be created between the first inner piece 123 and the second inner piece 123′ to receive the blade 110 when the knife 100 is folded.

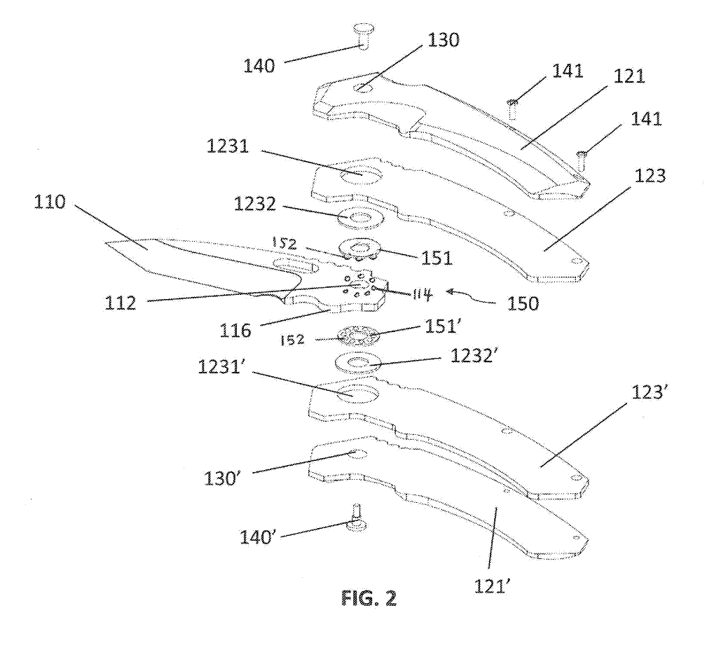

The handle 120 may include through holes 130 and 130′, each of which is located on a front end of the first side portion 121 and second side portion 121′ respectively. As shown in FIG. 2, the bearing 150 may include a first donut-shaped ring unit 151 disposed adjacent to a blade through hole 112 on one side of the blade 110 and a second ring unit 151′ disposed adjacent to the blade through hole 112 on the other side of the blade 110. A plurality of protruding units 152 facing the blade 110 are disposed on an outer surface of the first ring unit 151 and second ring unit 151′. In one embodiment, each protruding unit 152 is a hemisphere. A first protecting ring 1232 and a second protecting ring 1232′ are disposed on a surface opposite to the protruding units 152 of the first and second ring units respectively. The size of the protecting rings 1232 and 1232′ is slighting larger than the first and second ring units 151 and 151′, and the ring units 151 and 151′ are configured to guide the movement of the blade 110 without the spring-assisted mechanism.

More specifically, the blade 110 has a plurality of positioning protrusions 114 surrounding the blade through hole 112 on both sides of the blade 110 corresponding to the protruding units 152, and the positioning protrusions 114 and the protruding units 152 can be movably engaged with each other, so the movement and position of the blade 110 can be determined by relative positions between the positioning protrusions 114 on the blade 110 and the protruding units 152 on the ring units 151 and 151′. Thus, the movement of the blade 110 can be easily controlled and managed by the force exerted by the user. In one embodiment, each positioning protrusion 114 may be a hemisphere like the protruding units 152.

Still referring to FIG. 2, each of the first inner piece 123 and the second inner piece 123′ has an inner through hole 1231 and 1231′ respectively to receive corresponding protecting rings 1232 and 1232′. A pair of screws 140 and 140′ are configured to insert into handle through holes 130 and 130′, the inner through holes 1231 and 1231′, the protecting rings 1232 and 1232′, the ring units 151 and 151′, and the blade through hole 111 to pivotally secured the blade 110 on the front portion of the handle 120. It is noted that a plurality of auxiliary screws 141 are configured to further secure the first side portion 121, the first inner piece 123, the second side portion 121′ and the second inner piece 123′.

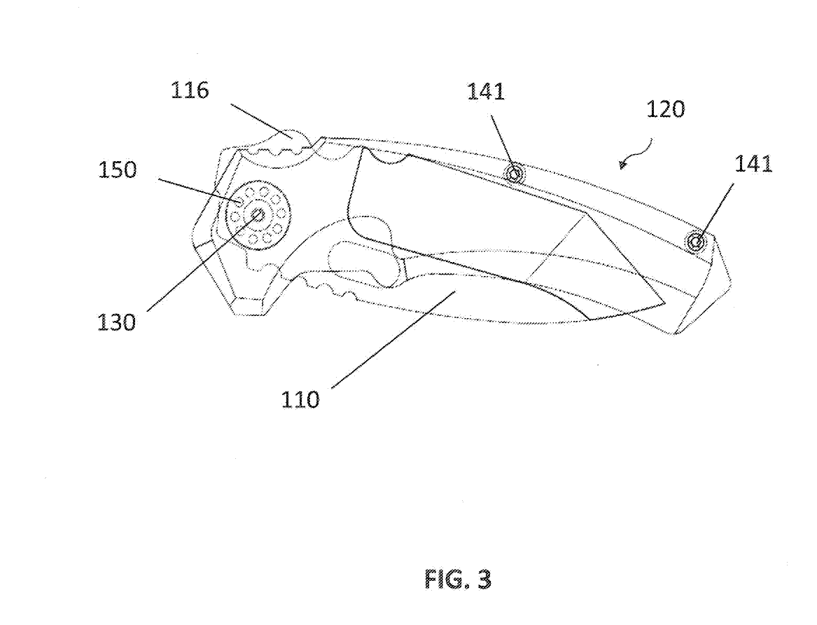

When in use, the knife in a closed position as shown in FIG. 3 is grasped with the rear end of the handle 120 towards the user's wrist and bottom of the handle 120 resting in the palm resulting in placement of a protruding portion 116 of the blade 110 in close proximity to the user's index finger. Force can then be applied to the protruding portion 116, so the blade can be rotated in a clockwise manner around the screws 140 and 140′ until the blade 110 is fully extended, which is about 180 degrees change from its closed position. It is noted that the extent of the clockwise movement of the blade 110 can be controlled by the force applied by the user. More specifically, as stated above, the movement of the blade 110 in the present invention can be guided by the positioning protrusions 114 on the blade 110 and the protruding units 152 on the ring units 151 and 151′, so the user can adjust the force exerted on the protruding portion 116 of the blade 110 to further control the movement of the blade 110.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A folding knife comprising a blade, a handle and a bearing located at a front end inside the handle, and the blade is pivotally connected with the handle and the bearing,
wherein the bearing includes a first ring unit disposed adjacent to a blade through hole on one side of the blade and a second ring unit disposed adjacent to the blade through hole on the other side of the blade, and a plurality of protruding units facing the blade are disposed on an outer surface of the first ring unit and second ring unit,
wherein the blade has a plurality of positioning protrusions surrounding the blade through hole on both sides of the blade corresponding to the protruding units, and the positioning protrusions and the protruding units are movably engaged to determined movement and position of the blade by relative position between the positioning protrusions on the blade and the protruding units on the first and second ring units.

2. The folding knife of claim 1, wherein the handle includes a first side portion, a first inner piece, a second side portion and a second inner piece, and a receiving space is created between the first inner piece and the second inner piece to receive the blade when the knife is folded.

3. The folding knife of claim 1, wherein a first protecting ring and a second protecting ring are disposed on a surface opposite to the protruding units of the first and second ring units respectively.

4. The folding knife of claim 1, wherein each of the positioning protrusions and protruding units is a hemisphere.

5. The folding knife of claim 3, wherein each of the first inner piece and the second inner piece has an inner through hole to receive corresponding protecting rings.

6. The folding knife of claim 1, wherein when the knife is folded, a force of a user is exerted to a protruding portion of the blade to drive the blade to rotate in a clockwise manner around the screws until the blade is fully extended.

7. The folding knife of claim 6, wherein the movement of the blade is controllable by the force of the user because of the movable engagement between the positioning protrusions on the blade and the protruding units on the first and second ring units.
